(19) United States
(12) Patent Application Publication
(10) Pub. No.: US 2009/0097952 A1
(43) Pub. Date: Apr. 16, 2009

(54) Method and device for transporting an elevator car drive machine

(75) Inventors: Bruce P. Swaybill, Farmington, CT (US); St.Bruce Pierre, Unionville, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Otis Elevator Company, Farmington, CT (US)

(21) Appl. No.: 11/990,353

(22) PCT Filed: Aug. 30, 2005
(86) PCT No.: PCT/US2005/030750

§ 371 Date: Feb. 12, 2008

(51) Int. Cl. B66B 11/00

(52) U.S. Cl. 414/589; 414/800

(57) ABSTRACT

The present invention includes a method and a device for transporting an elevator car drive machine within an elevator hoistway. The drive machine is secured to a movable carriage located in the hoistway and the carriage is moved in a horizontal direction of travel to move the drive machine horizontally within the hoistway.

### BACKGROUND OF THE INVENTION

The present invention relates generally to the field of elevator installation and maintenance. More specifically, the present invention relates to a method and a device for transporting an elevator car drive machine within an elevator hoistway.

A typical traction elevator system includes a car and a counterweight disposed in a hoistway, a plurality of ropes that interconnect the car and counterweight, and a drive machine having a drive pulley wheel engaged with the ropes to drive the car. The ropes, and thereby the car and counterweight, are driven by rotation of the drive pulley wheel. Typically, the drive machine, and associated equipment, are housed in a separate machine room.

A recent trend in the elevator industry has been to eliminate the separate machine room and locate the drive machine at a mounting location located near a ceiling of the hoistway. The installation of a drive machine in a hoistway typically entails lifting the drive machine into position from either a floor of the building or an elevator car. This typically requires the hoistway to be extended vertically to allow sufficient space to transport the drive machine to the mounting location. Expansions of the hoistway, however, can add to the overall construction cost.

### BRIEF SUMMARY OF THE INVENTION

The present invention includes a method and a device for transporting an elevator car drive machine within an elevator hoistway. The drive machine is secured to a movable carriage located in the hoistway so that the drive machine is elevated with respect to a mounting location. The carriage is moved in a horizontal direction of travel to move the drive machine horizontally within the elevator hoistway.

### BRIEF DESCRIPTION OF THE DRAWINGS

FIG. 1 is a front view of an elevator system including an elevator hoistway and a hoisting beam, with an elevator drive machine tethered to the hoisting beam and being lifted towards the hoisting beam.

FIG. 2. is a front view of the elevator system of FIG. 1 illustrating the drive machine of FIG. 1 being moved horizontally along the hoisting beam.

FIG. 3 is a front view of the elevator system of FIG. 1 illustrating the drive machine of FIG. 1 located above a mounting location.

FIG. 4 is a back view of a transport device attached to a backside of the hoisting beam of the elevator system of FIG. 1 for use in transporting the drive machine.

### DETAILED DESCRIPTION

The present invention includes a method and a device for transporting an elevator drive machine in an elevator hoistway. The method allows a drive machine to be transported to, and/or from, a mounting location located in an elevator hoistway near a ceiling of the hoistway, while requiring a minimal amount of vertical hoistway space.

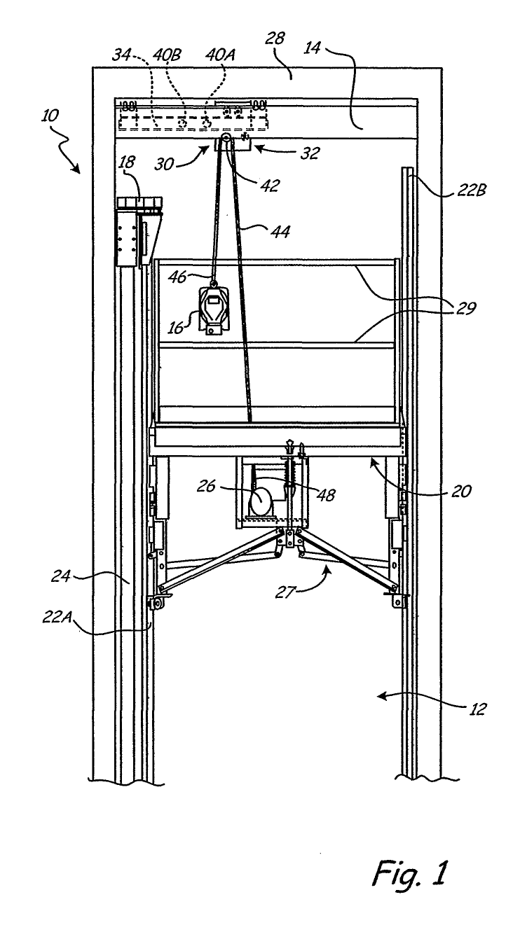

FIGS. 1-3 show front views of an elevator system 10, with a front wall removed for purposes of clarity. The front wall of elevator system 10 includes doors (not shown) for accessing floors of a building serviced by elevator system 10. Elevator system 10 includes a hoistway 12, a hoisting beam 14, a drive machine 16, a mounting location 18, a car platform 20, a pair of car rails 22A and 22B, counterweight rails 24, a counterweight (not shown), a winch 26, and a safety locking system 27. Hoistway 12 extends vertically through a building and includes a ceiling 28, with hoisting beam 14 extending across hoistway 12 in close proximity to ceiling 28.

Car platform 20 is movably mounted to car guide rails 22A and 22B for vertical passage through hoistway 12. Car platform 20 includes safety locking system 27 for holding car platform 20 in place within hoistway 12 while drive machine 16 is being installed. Car platform 20 is a floor of a partially-installed elevator car and is equipped with safety handrails 29.

Mounting location 18 provides a location for anchoring drive machine 16, which drives the fully-installed elevator car (not shown). Mounting location 18 is a bedplate supported by car rail 22 and counterweight rails 24, as shown in FIGS. 1-3.

Methods of the present invention may be used to transport drive machine 16 to, and/or from, mounting location 18. To transport drive machine 16 to mounting location 18, car platform 20 is vertically positioned within hoistway 12 to be in suitably close proximity to hoisting beam 14 and/or ceiling 28. Drive machine 16 is lifted vertically so that it is elevated with respect to mounting location 18 and moved in a horizontal direction of travel within hoistway 12 until positioned above mounting location 18. Next, drive machine 16 is lowered onto mounting location 18 and secured to mounting location 18. To transport drive machine 16 from mounting location 18 to another location within hoistway 12, the above method may be performed in reverse.

In some embodiments, drive machine 16 is tethered to hoisting beam 14 or another support member associated with hoistway 12 and lifted vertically via the tether until elevated with respect to mounting location 18. In an exemplary embodiment, drive machine 16 is moved in a horizontal direction of travel after drive machine 16 is elevated with respect to mounting location 18. However, in other embodiments, drive machine 16 may be moved in a horizontal direction of travel prior to, or while, being lifted towards a location that is elevated with respect to mounting location 18.

In some embodiments, a transport device is used to assist in the transport of drive machine 16 to, or from, mounting location 18. The transport device can be any device capable of coupling to hoisting beam 14 or another support member associated with hoistway 12 and assisting with moving drive machine 16 in a horizontal direction of travel within hoistway 12. In some embodiments, the transport device is configured to assist with vertically lifting drive machine 16 so that drive machine is elevated with respect to mounting location 18.

FIGS. 1-3 illustrate one embodiment of a method of the present invention that utilizes a transport device 30 to transport drive machine 16 to, or from, mounting location 18. Transport device 30 is mounted to hoisting beam 14 and includes a carriage 32 movably attached to a rail 34. Rail 34 is secured to hoisting beam 14 via couplings 38A and 38B. Carriage 32 is movable along rail 34 in a horizontal direction of travel along hoisting beam 14. Optional removable stops 40A and 40B are included in rail 34 to allow for control of the horizontal range of movement of carriage 32 along rail 34. Carriage 32 includes an optional pulley wheel 42 for engaging a cable 44 having ends 46 and 48.

Prior to engagement with carriage 32, cable 44 is in engagement with an overhead pulley wheel (not shown) secured to hoisting beam 14 (or another structure within hoistway 12 near ceiling 28). End 46 of cable 44 is attached to car platform 20 and end 48 is attached to winch 26 secured to car platform 20. This configuration allows winch 26 to drive platform 20 within hoistway 12.

As described above, elevator car platform 20 is positioned at a suitable location beneath hoisting beam 14. Safety locking system 27 is engaged to lock car platform 20 in place on car rails 22A and 22B. End 46 of cable 44 is detached from car platform 20 and cable 44 is disengaged from the overhead pulley wheel (not shown). Cable 44 is then fed over pulley wheel 42 of transport device 30. End 46 of cable 44 is secured to drive machine 16, thereby tethering drive machine 16 to transport device 30 (and hoisting beam 14), as shown in FIG. 1. Carriage 32 of transport device 30 is positioned between coupling 38A and removable stop 40A so that removable stop 40A restricts the horizontal range of motion of carriage 32. Winch 26 is then used to tension cable 44 and lift drive machine 16 towards hoisting beam 14 until drive machine 16 is elevated with respect to mounting location 18 and in close proximity to hoisting beam 14.

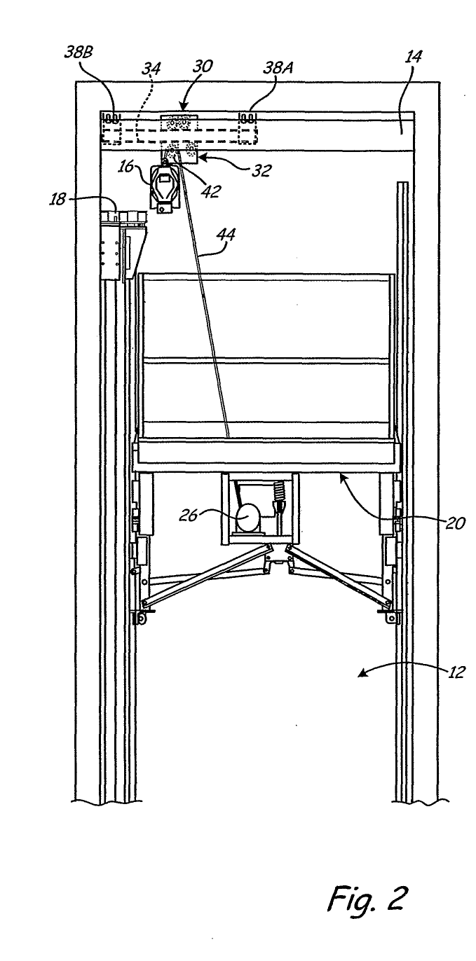

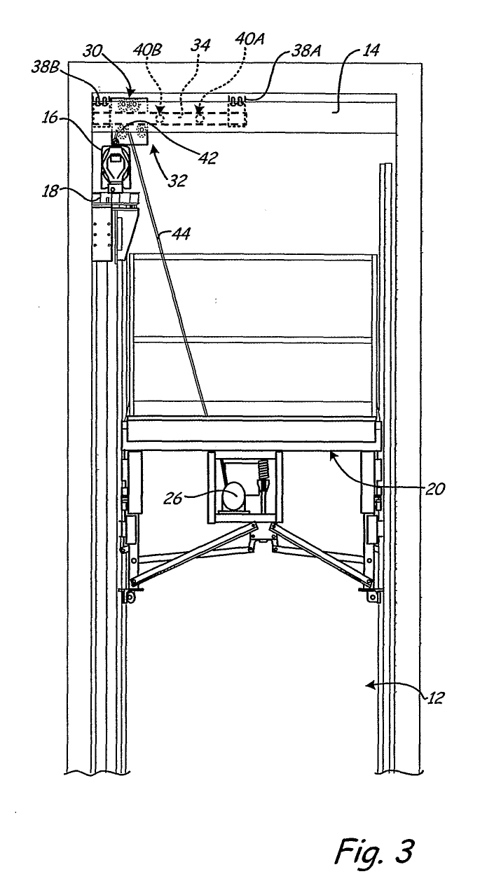

Drive machine 16 is then optionally connected to carriage 32 to remove tension from cable 44 and transfer the weight of drive machine 16 to carriage 32, as shown in FIG. 2. Stop 40A is then removed, or otherwise disengaged, and carriage 32 and drive machine 16 are moved horizontally along rail 34 (and hence hoisting beam 14) towards mounting location 18, as shown in FIG. 2. The horizontal movement can be caused, for example, by an operator applying sufficient force in the horizontal direction to either carriage 32 or drive machine 16. Drive machine 16 is positioned above mounting location 18 between couplings 38B and stop 40B, as shown in FIG. 3. Stop 40B is engaged to prevent the horizontal component of the tension on cable 44 from causing carriage 32 to move horizontally towards coupling 38A and away from mounting location 18. Drive machine 16 is then unsecured from carriage 32 so that cable 44 is again carrying the weight of drive machine 16. In some embodiments, winch 26 may be engaged to tension cable 44 and assist in unsecuring drive machine 16 from carriage 32. The tension on cable 44 is adjusted to lower drive machine 16 onto mounting location 18. Drive machine 16 is secured to mounting location 18 and untethered from end 46 of cable 44.

In some embodiments, drive machine 16 is transported to, or from, mounting location 18 after completion of an elevator car. In such situations, winch 26 is secured to the completed elevator car at any suitable location including, for example, the roof of the completed elevator car.

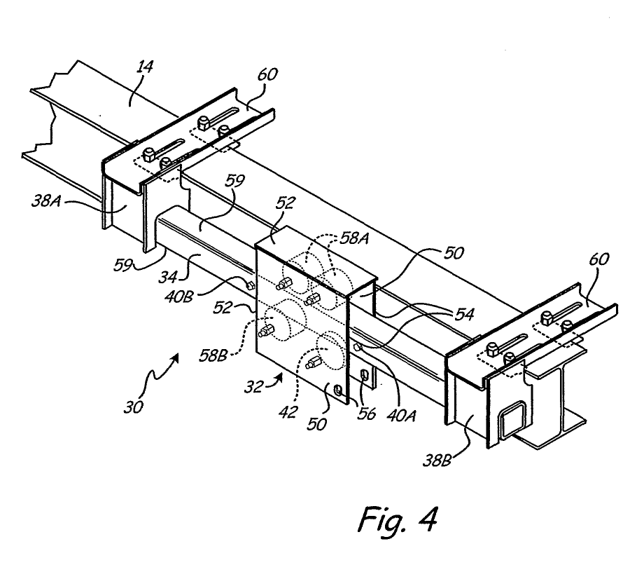

FIG. 4 shows a back view of transport device 30 of FIGS. 1-3 mounted to the backside of hoisting beam 14, with the orientation of FIG. 4 reversed with respect to the orientation of FIGS. 1-3. Although shown mounted to the backside of hoisting beam 14 in FIGS. 1-4, in some embodiments, transport device 30 can be configured to be mounted to the front side of hoisting beam 14. Transport device 30 has a vertical profile that is substantially similar to the vertical profile of hoisting beam 14, which minimizes the amount of vertical hoistway space required to transport drive machine 16 to, or from, mounting location 18. This reduces or eliminates the need to expand the vertical height of hoistway 12 to accommodate for transport of drive machine 16. In other embodiments, transport device 30 may have a vertical profile that is substantially less or substantially greater than the vertical profile of hoisting beam 14.

As discussed above, carriage 32 is movably attached to rail 34 between spaced couplings 38A and 38B, which attach to rail 34 at opposite ends of rail 34. Rail 34 and couplings 38A and 38B are configured so that rail 34 is oriented generally parallel to hoisting beam 32, thereby allowing carriage 32 to move generally parallel to hoisting beam 14. Carriage 32 includes a pair of opposing sidewalls 50 having an inside edge 52 and an outside edge 54. Sidewalls 50 define a channel to receive rail 42 and are connected by a brace 52. Each of sidewalls 50 has an opposing mounting hole 56 located near outside edge 54 for receiving a rod (see FIG. 2) or other fastener to secure drive machine 16 directly to carriage 32. Drive machine 16 can be equipped with lifting eyes or any other attachment structure(s) known in the art to receive the rod or other fastener.

Rollers 58A and 58B are rotatably mounted between sidewalls 50. In the embodiment of FIG. 4, rail 34 is an elongated support with a pair of opposing surfaces 59 configured to engage rollers 58A and 58B. Carriage 32 may include any number of rollers 58A and/or 58B in any possible configuration. As discussed above, in this embodiment, carriage 32 includes a plurality of top rollers 58A and a single bottom roller 58B. The inclusion of a plurality of top rollers 58A stabilizes carriage 32 relative to rail 34—as does the inclusion of bottom roller 58B.

Pulley wheel 42 is rotatably connected to carriage 32 and is positioned between sidewalls 50. Pulley wheel 42 and mounting holes 56 are offset towards inside edge 52 to allow drive machine 16 to be carried ahead of carriage 32 (see FIG. 3) when carriage 32 is pushed against coupling 38A, thereby allowing drive machine 16 to be centered on mounting location 18. Given this offset, bottom roller 58B is offset towards outside edge 54 to prevent carriage 32 from rotating counterclockwise on rail 34.

Transport device 30 may include any number of couplings utilizing any fastening system known in the art for attaching a member to an I-beam. As shown in FIG. 4, transport device 30 includes a pair of couplings 38A and 38B, each of which include a rail clip 60 for securing the respective coupling to hoisting beam 14. Examples of other suitable fasteners for fastening couplings 38A and/or 38B to hoisting beam 14 include bolts, clamps, or any other suitable fasteners known in the art. In other embodiments, any number of couplings may be used to secure transport device 30 to hoisting beam 14. The couplings can be attached to rail 34 using any type of attachment known in the art including, for example, welding, bolting, and combinations thereof.

As shown, in FIG. 4, transport device 30 includes two spaced and removable stops 40A and 40B. Any type and number of stops may be included in transport device 30 in any spacing configuration. In one embodiment, stops 40A and 40B comprise screws and rail 34 includes a pair of spaced holes to receive the screws.

Mounting holes 56 and pulley wheel 42 are but two examples of securing means that may be included in transport device 30 to secure drive machine 16 to carriage 32. Any other means known in the art may be included in transport device 30 to facilitate the securing of drive machine 16 to carriage 32 including, for example, fasteners such as bolts, clamps, screws and/or means for receiving the fasteners.

Transport device 30 is but one example of a transport device that may be used in conjunction with methods of the present invention. Any type of device may be used in conjunction with methods of the present invention that is capable of coupling to one or more support members associated with hoistway 12 and includes a carriage capable of moving drive machine 16 in a horizontal direction of travel within hoistway 12 so that drive machine 16 is elevated with respect to mounting location 18. In some embodiments, carriage 32 may be directly, and movably attached, to hoisting beam 14.

Hoisting beam 14 is one example of a support member associated with hoistway 12 to which transport device 30 may be secured. Transport device 30 may also be secured to any other suitable support member or members known in the art for use with hoistway 12. Transport device 30 may include any type and number of couplings known in the art for securing rail 34 to such support member(s). In one embodiment, transport device 30 is suspended from ceiling 28 of hoistway 12.

Thus, as described above, the methods and transport device of the present invention, provide a means for transporting an elevator drive machine to, and/or from, a mounting location within an elevator hoistway.

Although the present invention has been described with reference to preferred embodiments, workers skilled in the art will recognize that changes may be made in form and detail without departing from the spirit and scope of the invention.

1. A method for transporting a drive machine for driving an elevator car, the method comprising:
securing the drive machine to a movable carriage located in an elevator hoistway so that the drive machine is elevated with respect to a mounting location, the carriage movable in a horizontal direction of travel; and
moving the carriage in the horizontal direction to move the drive machine horizontally within the elevator hoistway.

2. The method of claim 1, and further comprising:
lifting the drive machine in the elevator hoistway so that the drive machine is elevated with respect to the mounting location.

3. The method of claim 2, wherein lifting the drive machine comprises lifting the drive machine from the mounting location so that the drive machine is elevated with respect to the mounting location.

4. The method of claim 2, wherein the drive machine is lifted in the elevator hoistway by adjusting a tension on a flexible cable secured to the drive machine, the cable operably connected to the carriage and a winch.

5. The method of claim 4, wherein the cable engages a pulley wheel rotatably connected to the carriage.

6. The method of claim 4, wherein the winch is secured to the elevator car.

7. The method of claim 4, wherein, after lifting the drive machine, the drive machine is connected to the carriage to reduce the tension on the cable.

8. The method of claim 1, and further comprising:
moving the carriage in the horizontal direction until the drive machine is positioned above the mounting location and lowering the drive machine onto the mounting location.

9. The method of claim 1, wherein the mounting location comprises a bedplate secured to a car rail and a pair of counterweight rails.

10. The method of claim 1, wherein the carriage is movably attached to a rail that is secured relative to the elevator hoistway.

11. The method of claim 10, wherein the rail is coupled to a hoisting beam located in the elevator hoistway.

12. A device for installing a drive machine for driving an elevator car, the device comprising:
a rail;
a first coupling attached to the rail, the first coupling adapted to secure the rail relative to a support member of an elevator hoistway;
a carriage movably attached to the rail; and
means for securing the drive machine to the carriage.

13. The device of claim 12, wherein the support member comprises a hoisting beam and the first coupling is configured to attach the device to the hoisting beam so that the rail is generally parallel to the hoisting beam.

14. The device of claim 13, wherein the carriage is configured to move in a horizontal direction of travel along a side of the hoisting beam.

15. The device of claim 12, and further comprising:
a pulley wheel rotatably attached to the carriage to receive a winch cable to lift the drive machine towards the carriage.

16. The device of claim 12, wherein the means for securing the drive machine to the carriage comprises means for connecting the drive machine to a housing of the carriage.

17. The device of claim 12, wherein the carriage includes a plurality of rollers for engaging the rail and allowing the carriage to move relative to the rail.

18. The device of claim 12, wherein the carriage comprises:
a housing with a pair of opposing sidewalls configured to define a channel to receive the rail; and
a plurality of rollers rotatably connected to the opposing sidewalls to engage the rail and allow the housing to move relative to the rail.

19. The device of claim 12, wherein the rail includes a removable stop configured to restrict movement of the carriage relative to the rail.

20. The device of claim 12, and further comprising:
a second coupling attached to the rail and spaced from the first coupling, the carriage attached to the rail between the first and second couplings.
